(19) United States
(12) Patent Application Publication
(10) Pub. No.: US 2005/0115123 A1
(43) Pub. Date: Jun. 2, 2005

(54) Assembly for mounting an advertisement sheet and a method thereof

(76) Inventor: Noam Weinberg-Sehayek, Tel-Aviv (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/513,042

(22) PCT Filed: Apr. 29, 2003
(86) PCT No.: PCT/IL03/00342

(30) Foreign Application Priority Data
May 1, 2002 (IL) 149432

(51) Int. Cl. G09F 7/02

(52) U.S. Cl. 40/611.01; 40/606.03

(57) ABSTRACT

The present invention disclosed an assembly useful for mounting an advertisement sheet of a side-wall of a cargo container and to a rapid, non-destructive and reversible method for its deployment thereof. More specifically, said novel assembly is having at least one anchoring device adapted to mate the frame of said sheet with the frame of said container, by a means of one or more boom-pockets of said container. Said assembly and method eliminate any permanent damage or alternation of said container, and further free of pre-requirement of exposing the inner portion of said container in order to mount the said sheet on said wall.

### FIELD OF THE INVENTION

The present invention relates to an assembly especially useful for mounting an advertisement sheet and to a method thereof The preset invention especially relates to said assembly adapted for mounting an advertisement on a wall of a transport container and to a rapid, non-destructive and reversible method for its deployment thereof.

### BACKGROUND OF THE INVENTION

Outdoor advertisement is characterized by an ever-increasing demand, yet the accessibility of potential customers to an immediately available, cheap and effective platform for the said advertisement is rather low. U.S. Pat. No. 6,101,751 to Hicks and U.S. Pat. No. 6,305,111 to Opdahl present a rigid or elastic substrates upon which an advertising message may be printed in attachable to the side of a truck in a way that prevents the substrate from flapping when the truck is moving at high speeds. The mounting of said substrate is enabled by affixing an extended recess in the side wall of the truck. Said affixing techniques are evolved with drilling the wall and mounting an anchoring device. A device useful for anchoring said substrate without permanent alternation of said wall or any other member of the wall infrastructure was not yet presented. U.S. Pat. No. 6,276,082 to Richards et al. and other inventions present a mounting for a sheet that has a bead about its periphery, having frame members and an elongated retainer includes a flange to be permanently affixed to the surface of a truck's wall. Said construction is not enabling to mount said device reversibly and rapidly on the outer side of a container without altering the shape of the wall or drilling holes in it. Moreover, mounting of said frame to a planar wall of a container require the installer to be inside said container, and thus eliminates the possibility to install said devices in sealed containers. It acknowledged that cargo containers are most rapidly shipped in order to decrease transport and storage costs. Additionally, said cargo container is to be subject to surface transported via trucks and trails across several counties, or more specifically, across several advertisement regions. Thus, using a cargo container as a cost-effective board for rapid, and multi regional advertisement is limited.

### SUMMARY OF THE INVENTION

It is thus the object of the present invention to present a useful assembly, especially adapted for a rapid, reversible and non-destructive mounting of an advertisement sheet on a wall of a sealed container as defined in the present invention, an particularly a cargo container, having at least one anchoring device adapted to mate with said container, without causing any permanent damage or alternation of said container. In a most preferred embodiment of the present invention, said container has boom-pockets, especially designed to enable the lifting of said container by a cargo boom, wherein said boom-pockets have a gradually elliptical opening. The assembly is having an anchoring device, adapted to reversible and non-destructive mate with said pocket; a cable; and an advertisement sheet having sleeves in at least two of its edges, adapted to accommodate said cable.

According another preferred embodiment of the present invention, said anchoring device is having a pin member comprising a proximal rim characterized by having a lever and gradually round shape opening, adapted to accommodate a frame cable; and a distal rim characterized by a gradually elliptical cross section. Said anchoring device is further characterized with a distal rim which is adapted to mate with said elliptical opening of the boom pocket by means of shape and size, so when said distal rim is in congruence with said pocket, the insertion of said pin into said opening is enabled; and when said pin is twisted to about 90° from said congruence configuration, the exit of said pin from said pocket is prevented.

According another preferred embodiment of the present invention, said anchoring device is having gradually a round shape cross section, and comprising a proximal rim having a lever, and an opening adapted to accommodate a frame cable; and a distal rim having anchors in connection with said lever. The device also adapted so said anchors are useful to be located either inside the bore of said device, or alternatively, to partly protrude outside of said bore, thus to enable the anchoring of said device inside the boom-pocket of the container.

It is further acknowledged that the assembly defined above is useful for mounting an advertisement sheet having a sleeve is its edge, on a side wall of container comprising an anchoring device having means to reversible and non-destructive mating of said sheet with said container; and a cable, having means to connect said sleeve and said anchoring device. Said assembly may additionally comprise of a ratchet having means to provide tension to said cable. Said ratchet is anchored, according a preferred mode of the present invention, to a boom-pocket by means of the anchoring device.

It is also appreciated that the aforementioned anchoring device may be adapted to mate the advertisement sheet with the wall of the container by means selected from vacuum and magnetic force. The said magnetic force is possibly enabled by means of electromagnets that are in communication with an electric source, selected from the vehicle battery or any other battery designed to supply sufficient power to said electromagnets.

The assembly according to the present invention is alternatively having means to be dressed on said container. Said means are comprises at least one wing to be mounted on the container said wall and an anchoring device, designed to be affixed on either the side wall or the upper wall of said container.

According to one preferred embodiment of the present invention, the assembly hereto defined comprising at least one adapter, having either reversible or irreversible means to mount the opening accommodates the cable and/or a ratchet, on a suitable board (such as walls, constructions, truck side walls etc.).

It is in the scope of the present invention that the above-defined assembly comprising a wind deflector having means to attach at least one rim of the sheet to the wall of the container. Additionally or alternatively, said assembly may comprise of means to illuminate said advertisement sheet.

It is still another object of the present invention to provide an advertisement sheet mounted by an anchoring assembly as defined above.

Lastly, an object of the present invention is to provide a useful method for the deployment of the anchoring device as defined above, comprising mating the advertisement sheet by means of said anchoring device without any constant damage or any alternation of said container.

In one preferred embodiment of the present invention, said method comprises of mating the anchoring devices defined above to the wall of the container, by means of inserting each of said anchoring device, comprising gradually elliptical end at its distal rim, to the opening of a boom-pocket, comprising gradually elliptical cross section, so said elliptical end of said pin is congruence to the gradually elliptical opening; twisting said pin member by means of its lever to about 90°, respectively to said congruence position, so said device in anchored in said boom-pocket; inserting a cable through the sleeve of the advertisement sheet and to the opening located in the proximal end of each of said anchoring device; and lastly, locking said cable so said advertisement is effectively mounted on said side wall of the container. According to the present invention, said locking is specifically enabled by means of operating a ratchet.

It is further in the scope of the present invention wherein the method defined above comprising the steps of inserting each of said anchoring device, to the opening of a boom-pocket; and twisting the lever of said device and thus anchoring the device in said boom-pocket.

### A BRIEF DESCRIPTION OF THE DRAWINGS

FIG. 1 presents a side and top view (A) of a standard cargo container and the same (B) wherein the assembly according to the present invention, comprising the advertisement sheet (5), is mounted on the side wall (1) of said container.

FIG. 2 present a side view of the anchoring device according to one preferred embodiment of the present invention and the method for its deployment in the boom pocket of the container.

FIG. 3 present a side view of the anchoring device according to another preferred embodiment of the present invention, comprising a lever (23) and lock mechanism (27).

FIG. 4 present a side view of the anchoring device according to another preferred embodiment of the present invention, comprising a key (23A), pulley accommodating the cable (21) and lock mechanism (27).

FIG. 5 present a side view of the anchoring device according to another preferred embodiment of the present invention, comprising a lever (23), pulley accommodating the cable (21) and lock mechanism (22A).

FIG. 6 present a side and top view of a standard container wherein a sheet advertisement is mounted on the upper wall and to two opposite side walls and rear wall of a standard cargo container.

### DETAIL DESCRIPTION OF THE INVENTION

The following description is provided, along all chapters of the present invention, to enable any person skilled in the art to make use said invention and sets forth the best modes contemplated by the inventor of carrying out this invention. Various modifications, however, will remain apparent to those skilled in the art, since the generic principles of the present invention have been defined specifically to provide for the assembly according to the present invention.

The present invention relates to an assembly useful for mounting an advertisement sheet of a side-wall of a cargo container and to a rapid, non-destructive and reversible method for its deployment thereof. More specifically, said novel assembly is having at least one anchoring device adapted to mate the frame of said sheet with the frame of said container, by a means of one or more boom-pockets of said container. Said assembly and method eliminate any permanent damage or alternation of said container, and further free of pre-requirement of exposing the inner portion of said container in order to mount the said sheet on said wall.

The terms ‘rapid’, ‘reversible’ and ‘non-destructive mounting’ is referring any procedures require mounting the said advertisement sheet on a wall adapted for said mounting, in a manner said wall in not permanently altered by any means. For example, the mounting device described in U.S. Pat. No. 5,664,354 may be in use.

The term container is preferably referring in the present invention to a standard cargo container comprising boom pockets. It is still in the scope of the present invention wherein the term container is refelting also to any transportable receptacle means such as truck panels, billboards, or trailers, and to any wall, preferably having round, polygonal or gradually elliptical pockets adapted to accommodate the encoring devices as defined in the present invention.

The term “gradually round” and “gradually elliptical” is referring in the present invention to any suitable shape enabling the rapid insertion of the said anchoring device into the boom-pocket and then to enable the affixing of said anchoring device in said pocket. Although polygonal shapes are also possible, round shapes comprising also semi-elliptical shapes and other various elliptical shapes are preferred in the present invention.

It is well in the scope of the present invention wherein the advertisement sheet comprising sleeves. The term ‘sleeves’ is hereby referred to any means useful for connecting the said advertisement sheet with a cable or any other frame network. Said advertisement is mounted the aforementioned container by means of anchoring device in connection with said advertisement sheet. The connecting means are preferably comprising a strong cable adapted to be accommodate inside sleeves, preferably located in the edge of said advertisement sheet. The said sheet is referring, according to the present invention, to sleeve, pocket, opening or any other means adapted to connect the sheet with the cable.

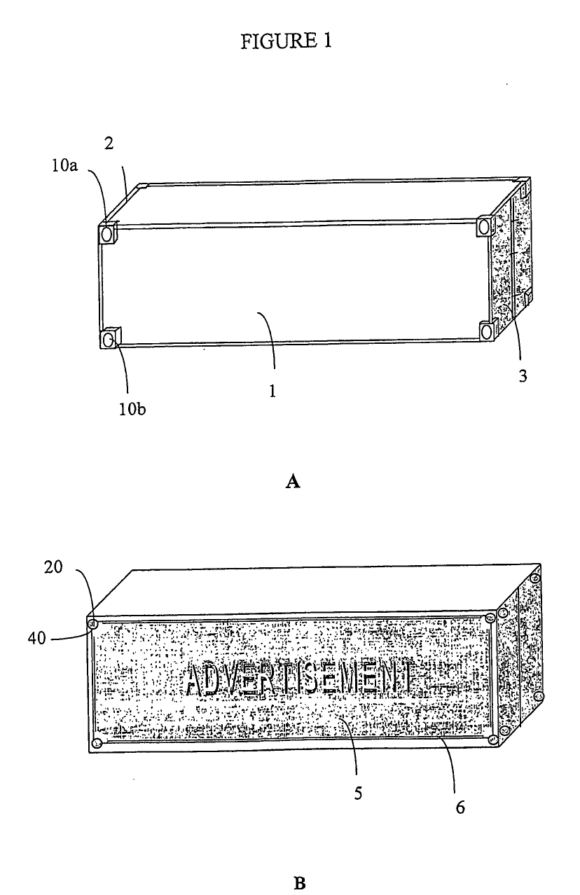

Reference is made now to FIG. 1 presenting a general scheme of a standard transport container (A) comprising a metallic frame (2). Said frame usually comprises of top-end and bottom-end transverse members, corner structures and corner fitting (10a). Said container also comprising side walls (1, for example) and at least one end door (3), usually made of aluminum substances. Said corner fitting (10a) comprising boom pocket, usually 24 such pockets, located in each corner of said side wall. Each of said boom pocket is having a gradually elliptical opening cut (10b), adapted to fit the means of said boom to lift said container.

It is acknowledged that according to the present invention, said term container is equally referring any container made of suitable material, including, yet not limited to metal matrixes as iron or aluminum ware, polymer or composite materials, suitable to contain and to transport cargo. It is further ackowledged that in particularly, said container is referred to a standard cargo container having the know dimensions of 20 or 40 feet long.

FIG. 1 furtherly presents (B) side view of the said container, wherein an advertisement sheet (5) is mounted on one side wall of said container (1). The outer face of said sheet (5) is preferably having said advertisement. Said sheet (5) is mounted on said wall (1) by means of anchoring assembly, having according one preferred embodiment of the present invention a frame (6). Said frame is enabled, according to a preferred embodiment of the present invention, by means of a sleeve located in the edge of said sheet and an long and strong cable accommodated inside said sleeve. According to another preferred embodiment of the present invention said cable is affixed on said wall (1) be means of the assembly defined in the present invention. It is in the scope of the present invention wherein the anchoring assembly additionally comprising means to lock the device so no an authorized used, and particularly opening of said advertisement is enabled.

It is acknowledge thus that said frame (6) is enabled by a cable, namely a frame cable. Nevertheless, other frames are suitable according to the present invention. Any either elastic or rigid frame, made of metal ware, polymers, composite materials, fabrics etc. is thus suitable to be implemented in said advertisement sheet. In the scope of the invention wherein the cable is locked in one anchoring device, preferably the one comprising the ratchet. The cable is further inserted inside sleeves of the advertisement sheet, wherein at each corner of the container the cable is grasped by an opening located in the proximal rim of the anchoring device. Said opening is a bore having a gradually round cross section, or a pulley, preferably a pulley in communication with an axle having a lager. In the end of the way, the cable is attached to the pulley of the ratchet or winch providing the means to pull the cable and to enable a tense frame for the advertisement sheet.

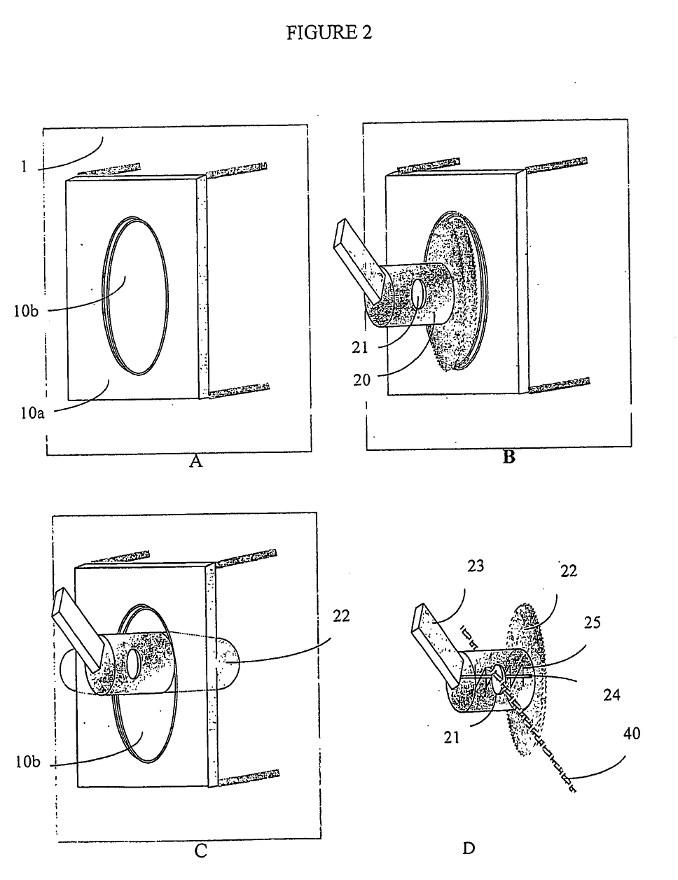

FIG. 2 schematically presents the corner fitting (10a) attached to at least one of said side wall (1) of the container. Said corner fitting is attached to a boom pocket having interalia a bottom, which is usually an integrative part of the container's side wall (1), and an outer board (10a), having a gradually elliptical opening in its middle (10b). In case of lifting the container, the boom is mate with the container by means of said boom pocket. According a preferred embodiment of the present invention, the aforementioned assembly has interalia a pin member. Said pin member is schematically presented in FIG. D and generally comprising the following: (a) proximal rim characterized by gradually round shape cross section (20) having a lever (23); and (b) distal rim, comprising a member having a gradually elliptical cross section (22). It is acknowledge that at least in one of said anchoring device, said pin comprises of an opening (21) designed to accommodate the cable (40). The proximal rim of said pin member has said elliptical cross section (20), is adapted to fit said elliptical opening of the boom pocket of the container (10b) by means of shape and size, so whereas said proximal rim is in congruence with said pocket (See FIG. B), the insertion of said pin into said opening is enabled. Wherein said pin is twisted to about 90° from said congruence configuration (See FIG. C) the exit of said pin from said pocket is avoided.

The lever (23) is designed to enable the insertion of the pin to said pocket, to allow its rotation and to secure its lock in said lock configuration. Thus, according a preferred embodiment of the present invention said lever is communication with the elliptical member (22) by means of assembly having also a connecting cable (24) which may contain also a spring (25).

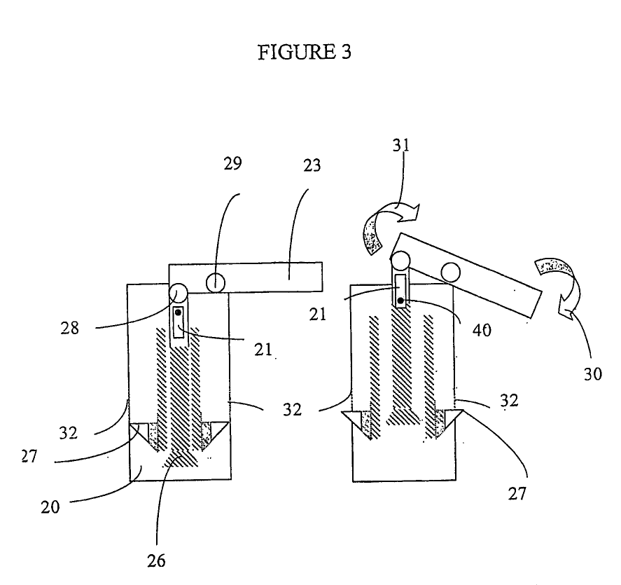

Reference is made now to FIG. 3, schematically presenting a cross section of the assembly according to the present invention. The anchoring device defined above is having gradually round shape cross section, and comprising (a) proximal rim having a lever (23); and (b) distal rim having anchors (27) in connection with said lever. Said device is designed to be located either inside the bore of said member in a configuration providing the insertion or escape of said device from the boom pocket (See slide A), or alternatively, to partly protrude of said bore. In this configuration, the anchors are fastening the device inside the pocket (See slide B). FIG. 3 shows the basic concept of the action-mechanism of said device: twisting the lever downward (30) facilitated by joints 28 and 29, is followed with the elevation of the member (26) so the at least two anchors (27) are pushed aside through an opening (32).

It is acknowledged that said device may have an opening (21) designed to accommodate a frame cable (40) which provide a tension to the frame of the advertisement sheet and additionally or alternatively provide means to anchor said sheet to the side wall of the container.

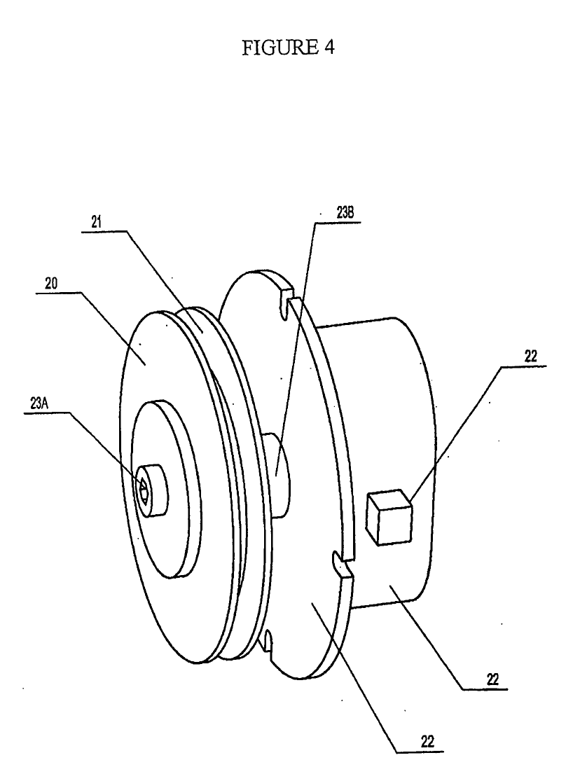

Reference is made now to FIG. 4, presenting the side view of the anchoring device according one preferred embodiment of the present invention from the proximal point of view shown the anchoring latch (22) in communication with a key (23). Said key is possibly attached to a lever. The body of said anchoring device is having a planar top and a gradually elliptical member attached to it in the distal rim, designed to fit by means of size and shape the gradually elliptical opening at the top cover of the boom pocket defined above (10b, FIG. 2), thus enabling a rapid insertion of the distal latch (22) inside said pocket. Said distal latch is having one or more lock mechanism (27). Twisting the key (23A) is follows with the rotation of the extension (23B), which potentially contain the key axle and the exit of the lock mechanism (27) outside the distal latch (22), thus locking the anchoring device inside the boom pocket of the container. A pulley (20) having a semi-open opening (21) is adapted to accommodate the cable. Said pulley is in communication with and axle having lagers.

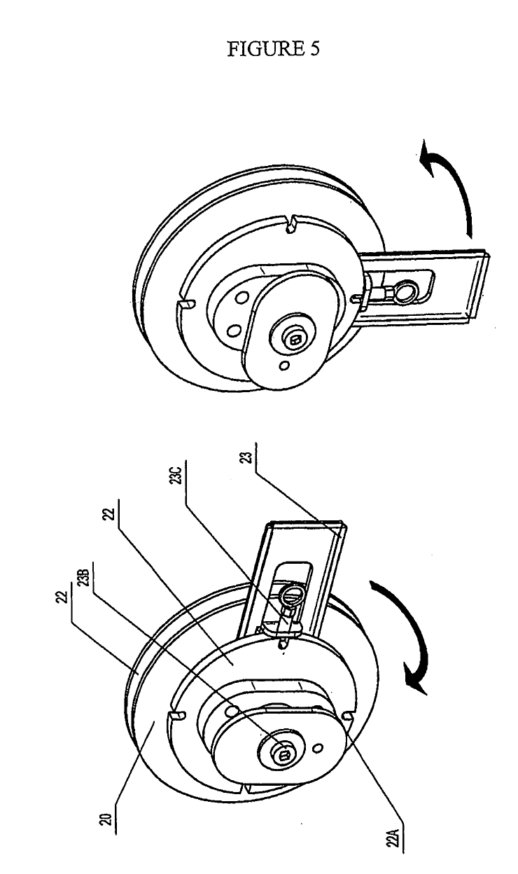

Reference is made now to FIG. 5, presenting an anchoring device according another preferred embodiment of the present invention from the proximal point of view (A). FIG. 5 is showing the anchoring latch (22A) in communication with the lever (23) by means of a longitudinal axle. The body of said anchoring device is having a planar top and a gradually elliptical member attached to it, designed to fit by means of size and shape the gradually elliptical opening at the top cover of the boom pocket defined above (10b, FIG. 2), thus enabling a rapid insertion of the distal latch (22) inside said pocket. From the same point of view (13), said elliptical latch (22A) is twisted to about 90 degrees by means of a lever 23. Said lever is forced to a predetermined movement by the holding members (23C), thus locldng the anchoring device inside the boom-pocket. Here again, a pulley (20) which is having a semi-open opening (21) is adapted to accommodate the cable. Said pulley is in communication with and axle having lagers.

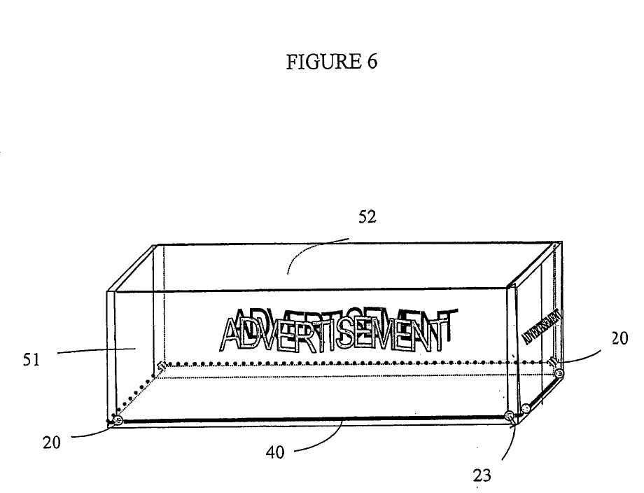

As was defined above, the assembly according to the present invention is alternatively having means to be dressed on the container. Said means are comprises at least one wing to be mounted on the container side (or rear-) wall and an anchoring device, designed to be affixed on either the side wall rear wall, and/or the upper wall of said container. A side view of another preferred embodiment of the present invention is presented in FIG. 6. The container is covered by a sheet member comprising the advertisement so both side walls (51 and 52) and the rear opening, are at least partly covered by said sheet. The sheet presented in FIG. 6 and any other sheet advertisement member is affixed to said container by the assembly defined in the present invention, namely by magnets, electromagnets, assemblies comprising pin attached to the boom pocket or any other available reversible, non-destructive and rapid means. It is in the scope of the present invention wherein a ratchet or any suitable means is in communication with a cable providing the tense frame of the advertisement sheet. In particularly, said ratchet is affixed to one anchoring device. In case of an advertisement sheet having a tent like configuration, as presented in FIG. 6, said ratchet may be affixed to anchoring device of every side wall and/or to participate in the structure-assembly of more then one of said walls. It is also acknowledged that said advertisement dressed on said cargo container is mounted by means of a cable, affixed to the anchoring devices at the respectively low positioning of the container, wherein the cable is being tense by means of a ratchet (23) located in on anchoring device.

1. An assembly especially adapted for a rapid, reversible and non-destructive mounting of an advertisement sheet on a wall of a cargo container, having at least one anchoring device adapted to mate with said container, without causing any permanent damage or alternation of said container.

2. The assembly according to claim 1; wherein said container has boom-pockets, especially designed to enable the lifting of said container by a cargo boom, wherein said boon-pockets have a gradually elliptical opening; said assembly comprising;
a. an anchoring device, adapted to reversible and non-destructive mate with said pocket;
b. a cable;
c. an advertisement sheet having sleeves in at least two of its edges, adapted to accommodate said cable.

3. The assembly according to claim 2, wherein the anchoring device is having a pin member comprising;
a. a proximal rim characterized by having a lever and gradually round shape opening, adapted to accommodate a frame cable; and
b. a distal rim characterized by a gradually elliptical cross section;
wherein said disatal rim is adapted to mate with said elliptical opening of the boom pocket by means of shape and size, so when said distal rim is in congruence with said pocket, the insertion of said pin into said opening is enabled; and when said pin is twisted to about 90° from said congruence configuration, the exit of said pin from said pocket is prevented.

4. The assembly according to claim 2, wherein the anchoring device is having gradually a round shape cross section, and comprising;
a. a proximal rim having a lever, and an opening adapted to accommodate a frame cable;
b. a distal rim having anchors in connection with said lever; wherein said anchors are designed to be located either inside the bore of said device, or alternatively, to partly protrude outside of said bore, thus to enable the anchoring of said device inside the boom-pocket of the container.

5. The assembly as defined in claim 2, useful for mounting an advertisement sheet having a sleeve is its edge, on a side wall of container comprising;
a. an anchoring device having means to reversible and non-destructive mating of said sheet with said container;
b. a cable, having means to connect said sleeve and said anchoring device.

6. The assembly as defined in claim 5, additionally comprising a ratchet having means to provide tension to said cable.

7. The assembly as defined in claim 5, wherein the ratchet is anchored to a boom-pocket by means of the anchoring device.

8. The assembly as defined in claim 1, wherein the opening is a bore in the proximal rim of the anchoring device having gradually round cross section.

9. The assembly as defined in claim 1, wherein the opening is a pulley attached to the proximal rim of the anchoring device, in communication to an axle having lagers.

10. The assembly according to claim 1, wherein the anchoring device is adapted to mate the advertisement sheet with the wall of the container by means selected from vacuum and magnetic force.

11. The assembly according to claim 10 wherein the magnetic force is enabled by means of electromagnets that are in communication with an electric source, selected from the vehicle battery or any other battery designed to supply sufficient power to said electromagnets.

12. The assembly according to claim 1 additionally having means to be dressed on the container, having at least one wing to be mounted on the container side wall and an anchoring device, designed to be affixed on either the side wall, the upper wall, the rear wall or the frontal wall of said container.

13. The assembly according to claim 1, additionally comprising a wind deflector having means to attach at least one rim of the sheet to the wall of the container.

14. The assembly according to claim 1, additionally comprising means to illuminate said advertisement sheet.

15. The assembly as defined in claim 1, adapted to mount advertisement sheet on walls, truck side walls, constructions or any suitable board.

16. The assembly according to claim 15, comprising at least one adapter, having either reversible or irreversible means to mount the opening accommodates the cable and/or a ratchet, on a suitable board.

17. A method for the deployment of the anchoring device as defined in claim 1, comprising mating the advertisement sheet by means of said anchoring device without any constant damage or any alternation of said container.

18. The method according to claim 17, comprising;
a. mating the anchoring devices according to claim 3 to the wall of the container, by means of:
i inserting each of said anchoring device, comprising gradually elliptical end at its distal rim, to the opening of a boom-pocket, comprising gradually elliptical cross section, so said elliptical end of said pin is congruence to the gradually elliptical opening;
ii twisting said pin member by means of its lever to about 90°, respectively to said congruence position, so said device in anchored in said boom-pocket;
b. inserting a cable through the sleeve of the advertisement sheet and to the opening located in the proximal end of each of said anchoring device; and
c. locking said cable so said advertisement is effectively mounted on said side wall of the container.

19. The method according to claim 17, wherein said locking is provided by means of a operating a ratchet.

20. The method according to claim 17, wherein the mating comprising the steps of;
a. inserting each of said anchoring device, to the opening of a boom-pocket;
b. twisting the lever of said device and thus anchoring the device in said boom-pocket.
